(19) United States
(12) Patent Application Publication
(10) Pub. No.: US 2008/0222374 A1
(43) Pub. Date: Sep. 11, 2008

(54) Computer system, management computer, storage system and volume management method

(75) Inventors: Yuri Hiraiwa, Sagamihara (JP); Koichi Murayama, Kawasaki (JP); Nobuyuki Osaki, Yokohama (JP)

Correspondence Address: Stanley P. Fisher;Reed Smith LLP, 3110 Fairview Park Drive, Suite 1400, Falls Church, VA, 22042-4503, US

(73) Assignee: Hitachi, Ltd.

(21) Appl. No.: 12/010,494

(22) Filed: Jan. 25, 2008

(30) Foreign Application Priority Data
Mar. 8, 2007 (JP) 2007-058398

(51) Int. Cl. G06F 12/16

(52) U.S. Cl. 711/162; 711/E12.103

(57) ABSTRACT

To provide a computer system in which the primary site administrator for managing all the sites can make the configuration of the authority to be granted beforehand for the administrator of each site to fill in for a part of its own authority, even during the absence such as at the time of disaster. The computer system includes one or more storage systems 1500 having a volume usable from a host computer 1100 and a management computer 1200 for managing the storage systems 1500, in which a plurality of users can use the same volume, wherein if a certain user makes an operation request to the volume with the copy configuration in which it is associated in source and destination with another volume, the management computer 1200 decides an operation authority to the user for the volume susceptible to the operation request, based on an attribute of the volume susceptible to the operation request, an attribute concerning the copy configuration of another volume with a still another volume, and an attribute of another volume, and suppresses the execution of the operation request, when the operation request is out of a permissible range of the operation authority.

The present application is based on and claims priority of Japanese patent application No. 2007-058398 filed on Mar. 8, 2007, the entire contents of which are hereby incorporated by reference.

### BACKGROUND OF THE INVENTION

1. Field of the Invention

The present invention relates to a computer system, a management computer a storage system and a volume management method, and more particularly to a user authority management method for use in a computer system having a memory device (volume).

2. Description of the Related Art

To cope with an increased data amount in a key system for public enterprise bearing the social infrastructure, a larger capacity of storage (storage system) was provided using a disk array control technique. A host computer (hereinafter referred to as a host) for the system recognizes the storage to perform the I/O for service, using an input/output device management technique.

The system is naturally asked for the high availability. Therefore, there is a demand for a so-called disaster recovery system in which even if a computer system storing a large amount of data is broken by a disaster, data is not lost. To meet such demand, a computer system for backing up data using a remote copy technique is provided. This involves storing the same data in the computer systems installed at two places (sites) sufficiently far away. If data of one computer system is updated, its update is reflected to another computer system by remote copy. Therefore, the identity of data in two computer systems is assured.

Further, to enhance the safety of data, a computer system is known in which computer systems are installed at three sites sufficiently far away from each other. In this computer system, the identity of data between a first computer system for use in normal service and a second computer system at regional site is assured by synchronous remote copy. On the other hand, the identity of data between the first computer system and a third computer system at regional site is assured by asynchronous remote copy. This constitution is called a “multi-target”.

In the case where the first computer system is disabled for service by a failure caused by a disaster, the second computer system takes over the service of the first computer system. At this time, if the second computer system can not be also used, the third computer system inherits the service of the first computer system. As a result, even when a severe disaster occurs, loss of data can be prevented.

Also, in the computer system in which the computer systems are installed at three sites, data is not duplicated between the second computer system and the third computer system during the normal operation. There is a data update method to assure the identity of data between the second computer system and the third computer system, when the second computer system inherits the service of the first computer system due to a failure of the first computer system. A technique for assuring the identity of data is called a “delta-resync”.

In a disaster recovery system composed of a plurality of sites, an instruction of changing the copy direction is issued from the storage management software for monitoring and operating the sites. There are various system configurations, including a configuration in which the system is normally operated, a configuration in which a failure occurs, and a recovery configuration corresponding to the failure, whereby the configurations are changed in accordance with a prescribed procedure. There is a storage management technique from the software on the management computer as the storage management software for monitoring and operating the sites.

Japanese Patent Laid-Open Publication No. 2006-235976 discloses an authority management technique on the operation using the copy function, involving changing the authority of the volumes making up a pair based on the states of the pair.

### SUMMARY OF THE INVENTION

In the disaster recovery system, the administrator is allocated to each site to continue the operation when each site suffers from disaster. For example, a primary site administrator is allocated to a primary data center of the multi-target, a local site administrator is allocated to a local data center, and a regional site administrator is allocated to a regional data center. In the normal operation, the primary site administrator makes the management, but when the primary site administrator as well as the primary data center suffer from disaster, and are disabled for the management, the local site administrator inherits the management to operate the system.

In this manner, each site administrator performs a different operation according to various configurations on the operation, whereby the authority management for managing the difference is required. For example, the local site administrator can not operate the storage in the regional data center during the normal operation. However, when the service host in the primary data center fails, and the local data center continues the service, a computer system in the local data center and a computer system in the regional data center are paired by delta-resync. During this state, the local site administrator is required to manage the computer system in the regional data center as a resource of the pair for the computer system managed by itself.

In the authority management technique as described in Japanese Patent Laid-Open Publication No. 2006-235976, the determination is made based on the conditions of volumes of the pair of object, whereby the authority could not be changed, when only the host fails with no change in the state of volume as described above, or when the state of the pair in the computer systems not directly related must be considered. In this case, to make the operation, it is required that the authority to be permitted after change is assigned beforehand to each site administrator of object. That is, there was a problem on the security because the authority is granted in an impermissible period before change.

The present invention provides a computer system comprising one or more storage systems having a volume usable from a host computer and a management computer for managing the storage systems, in which a plurality of users can use the same volume, wherein if a certain user makes an operation request to the volume with the copy configuration in which it is associated in source and destination with another volume, the management computer decides an operation authority to the user for the volume susceptible to the operation request, based on an attribute of the volume susceptible to the operation request, an attribute concerning the copy configuration of another volume with a still another volume, and an attribute of another volume, and suppresses the execution of the operation request, when the operation request is out of a permissible range of the operation authority.

With the invention, the primary site administrator for managing all the sites can make the configuration of the authority to be granted beforehand for the administrator of each site to fill in for a part of its own authority, even during the absence such as at the time of disaster. Further, the primary site administrator can give no permission to an operation request that should not be permitted in the impermissible site state for the administrator at each site to fill in for only a part of its own authority in a required state by making a change depending on the state of all the sites.

### BRIEF DESCRIPTION OF THE DRAWINGS

FIG. 1 is an explanatory diagram showing a basic organization of a computer system according to a first embodiment of the present invention;

FIG. 2 is an explanatory diagram showing the organization of plural sites and the relationship of copy pair in the first embodiment;

FIG. 3 is one example of an organization diagram of a management program in the first embodiment;

FIG. 4 is an explanatory diagram of an operation procedure 1 for disaster recovery in the first embodiment;

FIG. 5 is an explanatory diagram of an operation procedure 2 for disaster recovery in the first embodiment;

FIG. 6 is an explanatory diagram of an operation procedure 3 for disaster recovery in the first embodiment;

FIG. 7 is an explanatory diagram of an operation procedure 4 for disaster recovery in the first embodiment;

FIG. 8 is one example of an organization view of a copy group information table in the first embodiment;

FIG. 9 is one example of an organization view of a site state table in the first embodiment;

FIG. 10 is one example of an organization view of an authority table in the first embodiment;

FIG. 11 is one example of an organization view of a procedure authority relevant table in the first embodiment;

FIG. 12 is a flowchart for explaining a process of a procedure execution part in the first embodiment;

FIG. 13 is a flowchart for explaining a process of a site state determination part in the first embodiment;

FIG. 14 is a basic organization diagram of a computer system according to a second embodiment of the invention; and

FIG. 15 is one example of an organization view of ACL in the second embodiment.

### DETAILED DESCRIPTION OF THE PREFERRED EMBODIMENTS

The best mode for carrying out the present invention will be described below.

The invention is a computer system comprising a storage system, a host computer that refers to the storage system, and a management computer for making the configuration for the host computer to refer to the storage system, wherein in a complex organization composed of plural pairs such as three sites, the state of all the sites is discriminated in accordance with an operation request to the volume, based on the state information of the volume and a pair including the volume, and the state information of another pair to which the volume of the partner of the pair including the volume belongs. And the authority information at that time is extracted from the state of all the sites, and the authority information concerning the state of all the sites defined beforehand by the user, and whether or not the operation can be performed is decided.

In the following, the embodiments of a computer system, a management computer, a storage system and a volume management method of the invention will be described with reference to the drawings.

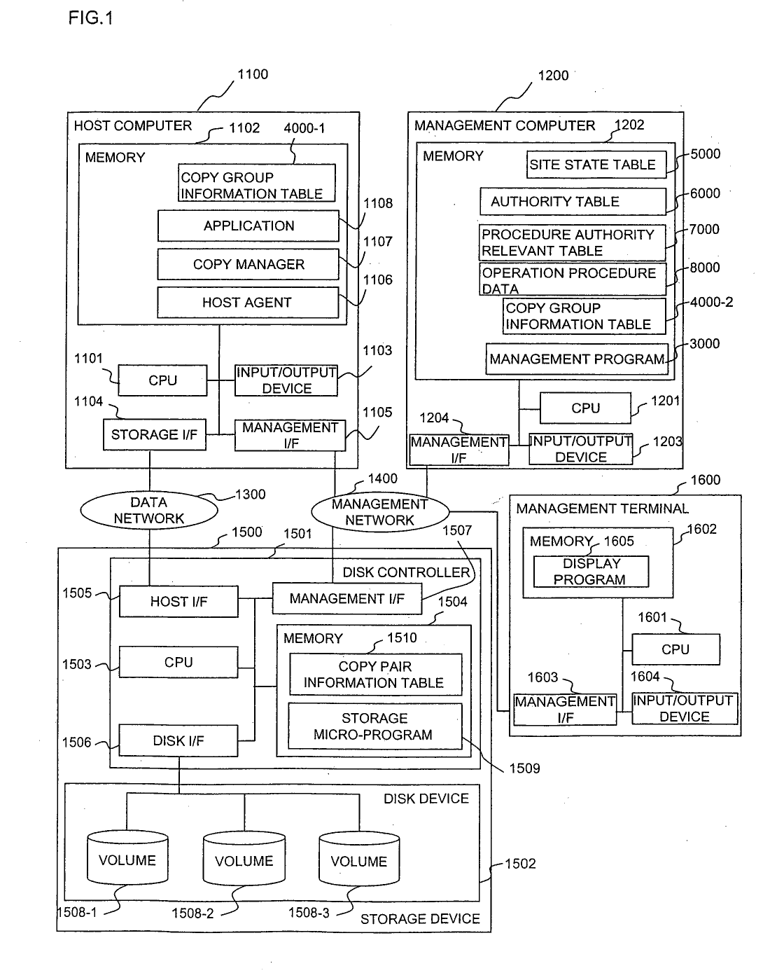

Referring to FIGS. 1 to 13, a first embodiment of the invention will be described below in detail. The input/output control from the computer and a volume using method based on the volume within the storage system are the same as shown in the prior art. The computer system of this embodiment consists of a management computer, and one or more storage systems.

FIG. 1 shows the organization of a computer system to which a computer system of this embodiment is applied. The computer system comprises a host computer 1100, a storage system 1500 accessed from the host computer 1100, a data network 1300 for connecting the host computer 1100 and the storage system 1500, a management computer 1200, a management terminal 1600, and a management network 1400 for connecting the host computer 1100, the storage system 1500, the management computer 1200 and the management terminal 1600. The host computer 1100 includes a host computer input/output device 1103 for managing the operation such as the configuration of the host computer 1100. The management computer 1200 has a management computer input/output device 1203 for managing the operation such as the configuration of the management computer 1200.

The data network 1300 is a data communication network, or an SAN (Storage Area Network) in this embodiment. The data network 1300 may be any other network than the SAN as far as it is the data communication network, for example, an IP network.

Also, the management network 1400 is a data communication network, or the IP network in this embodiment. The management network 1400 may be any other network than the IP network as far as it is the data communication network, for example, the SAN (Storage Area Network). Also, the data network 1300 and the management network 1400 may be the same network. Also, the management computer 1200 and the host computer 1100 may be realized by one computer.

For the sake of convenience, one storage system 1500 is provided at each site, one host computer 1100 is provided at each site and one management computer 1200 is provided at each site in this embodiment, but two or more of them may be provided at each site.

The storage system 1500 comprises a disk device 1502 and a disk controller 1501. The disk device 1502 stores data on a write request by the host computer 1100. The disk controller 1501 controls the processing of the storage system 1500.

The disk device 1502 comprises a plurality of volumes 1508-1, 1508-2 and 1508-3. The plurality of volumes 1508-1, 1508-2 and 1508-3 are generically called a volume 1508.

The volume 1508 is either a hard disk drive (HDD) that is a physical volume, or a logical device (Logical Device) that is a logical volume, and may be any type of volume in this embodiment. For the sake of explanation, three volumes 1508 are shown in FIG. 1, but any number of volumes 1508 may be provided.

The volume 1508 can make up a copy pair. The copy pair is composed of a volume 1508 of source (primary), and a volume 1508 of destination (secondary) that stores a duplicate of data stored in the volume 1508 of source.

The disk controller 1501 comprises a host I/F 1505, a management I/F 1507, a disk I/F 1506, a memory 1504 and a CPU 1503.

The memory 1504 stores a storage micro-program 1509 and a copy pair information table 1510.

The storage micro-program 1509 is executed by the CPU 1503. The storage micro-program 1509 controls the copy pair and acquires the state of the copy pair in accordance with a request from the host computer 1100.

The controls of the copy pair by the storage micro-program 1509 include a “create”, a “resync” and a “suspend”. In the “create”, the storage micro-program 1509 newly creates the copy pair. The “resync” indicates an operation of synchronizing the primary volume 1508 and the secondary volume 1508 to make the data of the primary volume 1508 and the data of the secondary volume 1508 consistent. The “suspend” indicates an operation of suspending the synchronization between the primary volume 1508 and the secondary volume 1508. The “create”, “resync” and “suspend” are also used as the response information of the state where the operation is performed for the copy pair of each volume 1508 acquired by the storage micro-program 1509.

The copy pair information table 1510 stores the information on the volume 1508 making up the copy pair among the volumes 1508 provided for the storage system 1500.

Though the storage micro-program 1509 and the copy pair information table 1510 are stored in the memory 1504 of the disk controller 1501 in this embodiment, the invention is not limited thereto. For example, the storage micro-program 1509 and the copy pair information table 1510 may be stored in a flash memory connected to the disk controller 1501, or the volume 1508 provided for the disk device 1502.

The host I/F 1505 is a network interface for connecting the storage system 1500 to the data network 1300. The host I/F 1505 sends or receives the data and a control command via the data network 1300 to or from the host computer 1100.

The management I/F 1507 is a network interface for connecting the storage system 1500 to the management network 1400. The management I/F 1507 sends or receives the data and a control command via the management network 1400 to or from the host computer 1100 and the management computer 1200.

The disk I/F 1506 is an interface for connecting the disk controller 1501 to the disk device 1502.

The host computer 1100 comprises a CPU 1101, a memory 1102, an input/output device 1103 such as a keyboard, a mouse, a display or the like, a storage I/F 1104, and a management I/F 1105, and is connected to each of them.

The storage I/F 1104 is a network interface for connecting the host computer 1100 to the data network 130. The storage I/F 1104 sends or receives the data or a control command via the data network 1300 to or from the storage system 1500.

The management I/F 1150 is a network interface for connecting the host computer 1100 to the management network 1400. The management I/F 1150 sends or receives the data or a control command via the management network 1400 to or from the storage system 1500 and the management computer 1200.

The memory 1102 stores a host agent 1106, a copy manager 1107, an application 1108 and a copy group information table 4000-1.

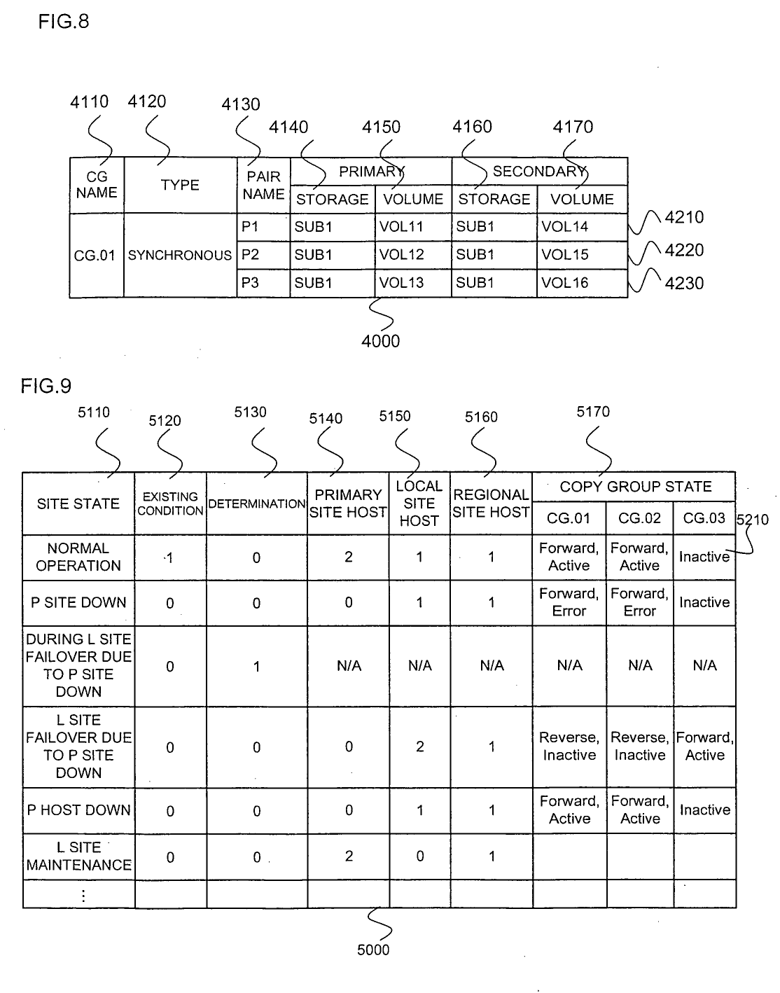

The copy group information table 4000-1 lists the information on the copy group in which a plurality of copy pairs are grouped. The copy group information table 4000 will be detailed using FIG. 8.

The host agent 1106, the copy manager 1107 and the application 1108 are placed on the memory 1102 provided for the host computer 1100, and performed by the CPU 1101.

The application 1108 reads or writes the data from or into the volume 1508 provided for the storage system 1500. For example, the application 1108 is a DBMS (Data Base Management System) or a file system.

The copy manager 1107 sends a request for controlling the copy pair and a request for acquiring the state of the copy pair to the storage micro-program 1509. A function of the copy manager 1107 sending a request for controlling the copy pair and a request for acquiring the state of the copy pair is provided by a command line interface or an application program interface so as to be executable by the administrator and other programs.

The host agent 1106 performs an operation of instructing the copy manager 1107 to issue a command or sending the information of the copy group information table 4000-1 to a management program 3000 in accordance with a request form the management program 3000 stored in the management computer 1200.

For the sake of convenience, one application program 1108 is provided in FIG. 1, but two or more application programs may be provided.

The management computer 1200 comprises a CPU 1201, a memory 1202, an input/output device 1203 such as a keyboard, a mouse, a display or the like, and a management I/F 1204, and is connected to each of them.

The management I/F 1204 is a network interface for connecting the management computer 1200 to the management network 1400. The management I/F 1204 sends or receives the data or a control command via the management network 1400 to or from the storage system 1500 and the host computer 1100.

The memory 1202 stores a copy group information table 4000-2, a site state table 5000, an authority table 6000, a procedure authority relevant table 7000, the operation procedure data 8000 and a management program 3000. The site state table 5000, the authority table 6000, the procedure authority relevant table 7000 and the operation procedure data 8000 are inputted via the input/output device 1203 and defined beforehand by the user. The tables will be detailed later using FIGS. 8 to 11.

The copy group information table 4000-2 has the same contents as the copy group information table 4000-1 stored in the host computer 1100.

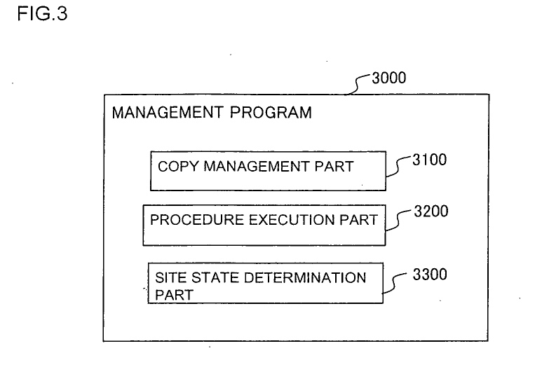

The management program 3000 is performed by the CPU 1201 provided for the management computer 1200. The management program 3000 has a function of creating the copy group information table 4000-2 by accepting the inputs from the user, and copying it to a copy group definition table 4000-1 of the host computer 1100. The details will be described later using FIG. 3. The management program 3000 performs the inputs from the user and the display to the user for this function via a graphical user interface (GUI) with a display program 1605 at a management terminal 1600.

The management terminal 1600 comprises a CPU 1601, a memory 1602, a management I/F 1603, and an input/output device 1604 such a keyboard, a mouse, a display or the like, and is connected to each of them.

The management I/F 1604 is a network interface for connecting the management terminal 1600 to the management network 1400. The management I/F 1604 sends or receives the data and a control command via the management network 1400 to or from the management computer 1200.

A display program 1605 is loaded on the memory 1602, and executed by the CPU 1601. The display program 1605 performs a GUI display for inputting or outputting the data from or to the user, which is required to execute the management program 3000, via the input/output device 1604.

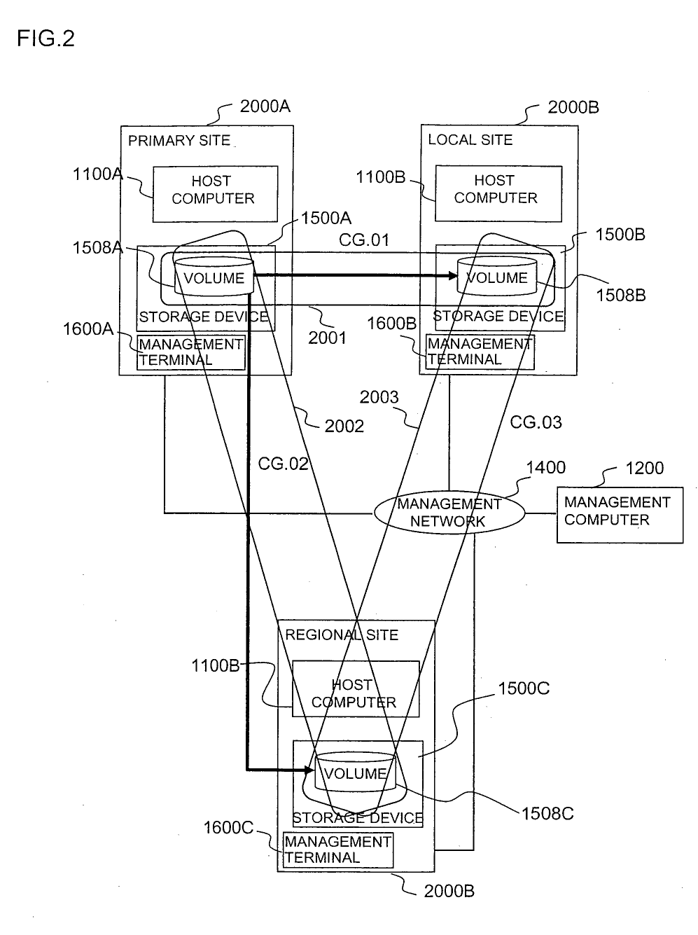

The overall organization of this embodiment will be described below using FIG. 2. A multi-target organization as shown in the prior art is taken in this embodiment. Also, the storage system 1500 has a “delta-resync” technique.

The site 2000 comprises the host computer 1100, the storage system 1500 and the management terminal 1600. The overall system is composed of three sites, a primary site 2000A, a local site 2000B and a regional site 2000C. The sites are connected to each other via the management network 1400, and the management computer 1200 is installed at every site or still another site. The sites are also connected via the data network 1300, which is not shown in FIG. 2.

The volume 1508A of the storage system 1500A at the primary site 2000A and the volume 1508B of the storage system 1500B at the local site 2000B are copied by synchronous copy. This configuration is represented as CG.01 as indicated at 2001 by the solid line.

The volume 1508A of the storage system 1500A at the primary site 2000A and the volume 1508C of the storage system 1500C at the regional site 2000C are copied by asynchronous copy. This configuration is represented as CG.02 as indicated at 2002 by the solid line.

The volume 1508B of the storage system 1500B at the local site 2000B and the volume 1508C of the storage system 1500C at the regional site 2000C are copied by asynchronous copy with delta-resync at the time of disaster. This configuration is represented as CG.03 as indicated at 2003 by the solid line.

In the following explanation, the primary site is simply denoted as “P site”, the local site as “L site”, and the regional site as “R site” for illustration.

FIG. 3 shows an organization of the management program 3000. The management program 3000 comprises a copy management part 3100, a procedure execution part 3200 and a site state determination part 3300.

The copy management part 3100 has a storage management function. That is, to make the copy management, the copy management part has a copy operation management function of acquiring the organizational information of the storage system 1500, managing the issuance of a copy control command upon an instruction of the user, instructing a copy manager 1107 to issue the copy control command by communicating with the host agent, acquiring the state information such as attribute concerning the copy of the volume 1508 for the storage system 1500 from the host agent, and acquiring the information of the host computer 1100. In making this management, the presence or absence of the authority of the user making the instruction is determined based on the site state table 5000 and the authority table 6000.

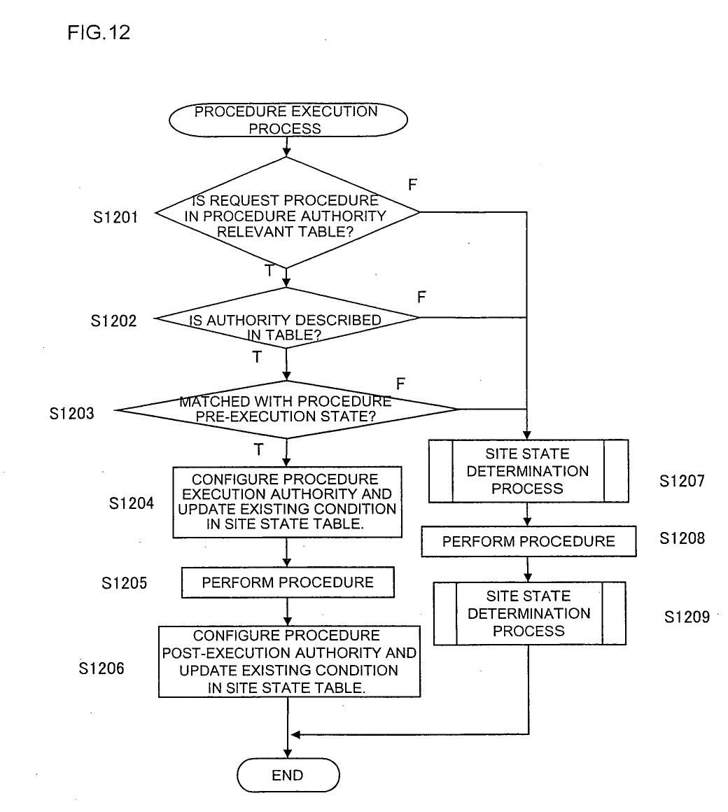

The procedure execution part 3200 changes the authority based on the procedure data 8000 in executing the procedure in the copy management part 3100 to make the authority management of this embodiment. This process will be described later using FIG. 12.

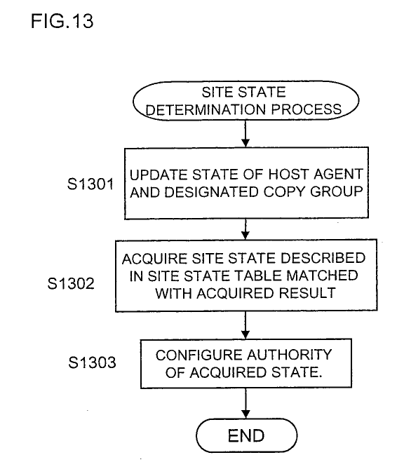

The site state determination part 3300 has a function of determining the site state based on the state information acquired by the copy management part 3100 to make the authority management of the embodiment. This process will be described later using FIG. 13.

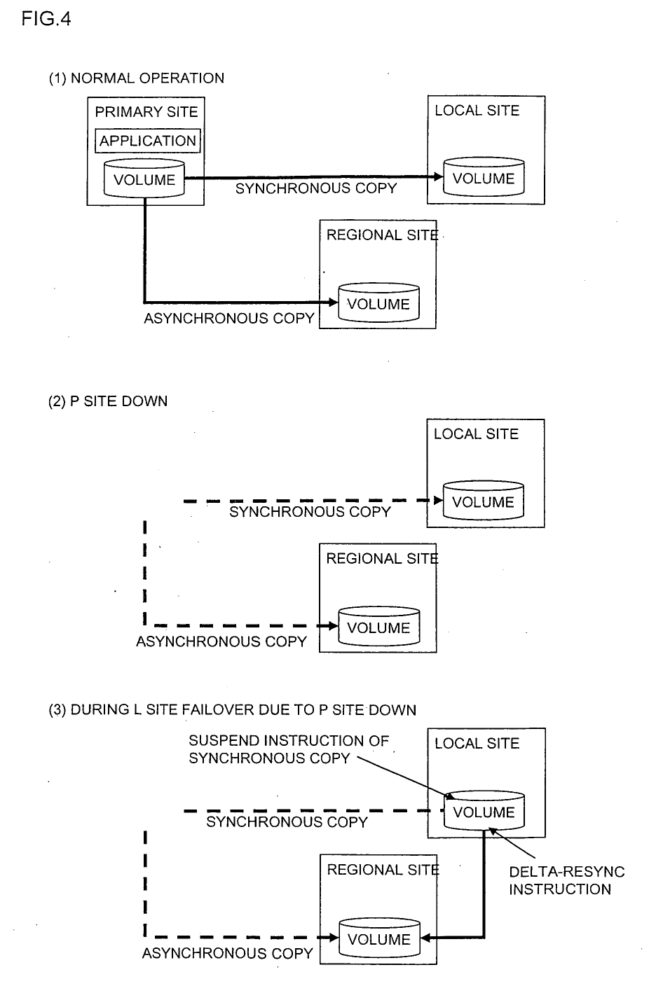

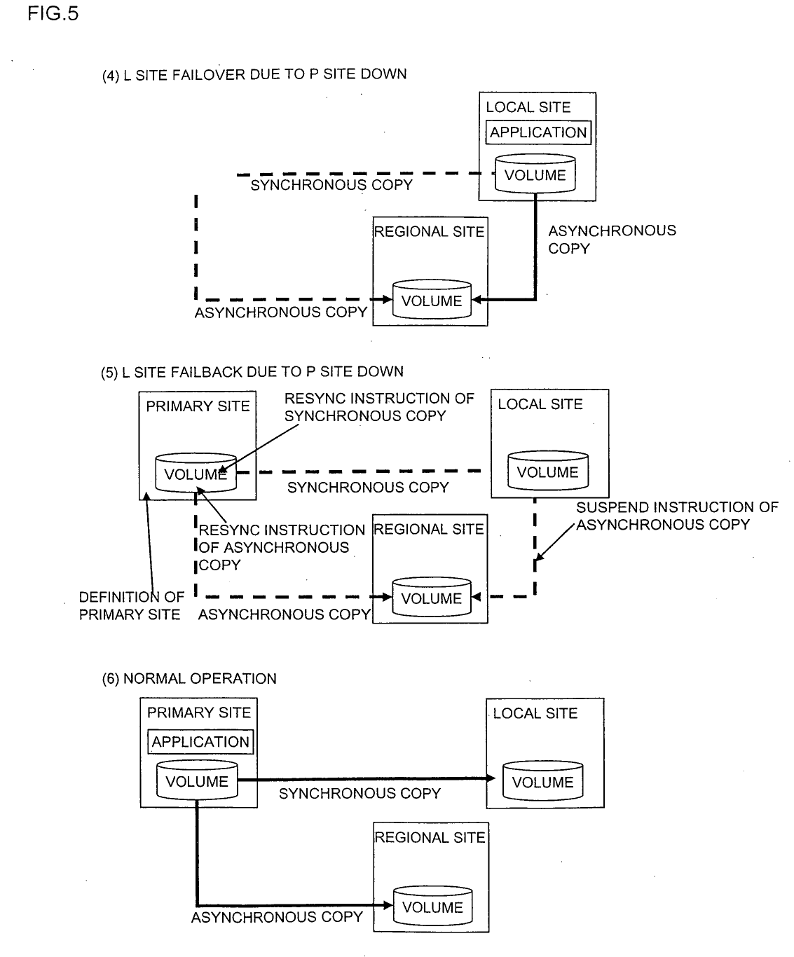

Referring to FIGS. 4 to 7, one example of the operation in the multi-target organization will be described below. First of all, the operation of “P site down” where the entire primary site suffers from disaster will be described below sing FIGS. 4 and 5.

The usual multi-target organization as shown in FIG. 4(1) is taken before disaster. This site state is called a “normal operation”.

Next, FIG. 4(2) shows the state where the entire primary site suffers from disaster. The primary site disappears, and the local site and the regional site are left. Each copy pair is in the “suspend” state. In the figure, the “suspend” state is indicated by the broken line. This site state is called a “P site down”.

Next, FIG. 4(3) shows the state where the local site is changing the organization to start the operation. The synchronous copy is suspended, the delta-resync is instructed to CG.03, and the asynchronous copy is started. These instructions are made by the local site administrator. This site state is called a “during L site failover due to P site down”.

FIG. 5(4) shows the state where the organization change of the FIG. 4(3) is completed. The host computer 1100B at the local site starts the execution of the application 1108, and the asynchronous copy from the storage system 1500B at the local site to the storage system 1500C at the regional site is performed. This site state is called an “L site failover due to P site down”.

FIG. 5(5) shows the state of the organization change for restoring the operation to the primary site because the installation of the primary site is recovered or newly installed after the operation of FIG. 5(4). First of all, when the installation of the primary site is new or changed, the copy definition information for CG.01 and CG.02 is edited. Next, the asynchronous copy of CG.03 is suspended, and the copy of CG.01 and CG.02 is restarted. This site state is called an “IL site failback due to P site down”.

The “normal operation” as shown in FIG. 5(6) is restored by the organization change of FIG. 5(5). This state is the same as shown in FIG. 4(1).

The above description is involved in the procedure and organization for the operation associated with the “P site down” in the multi-target.

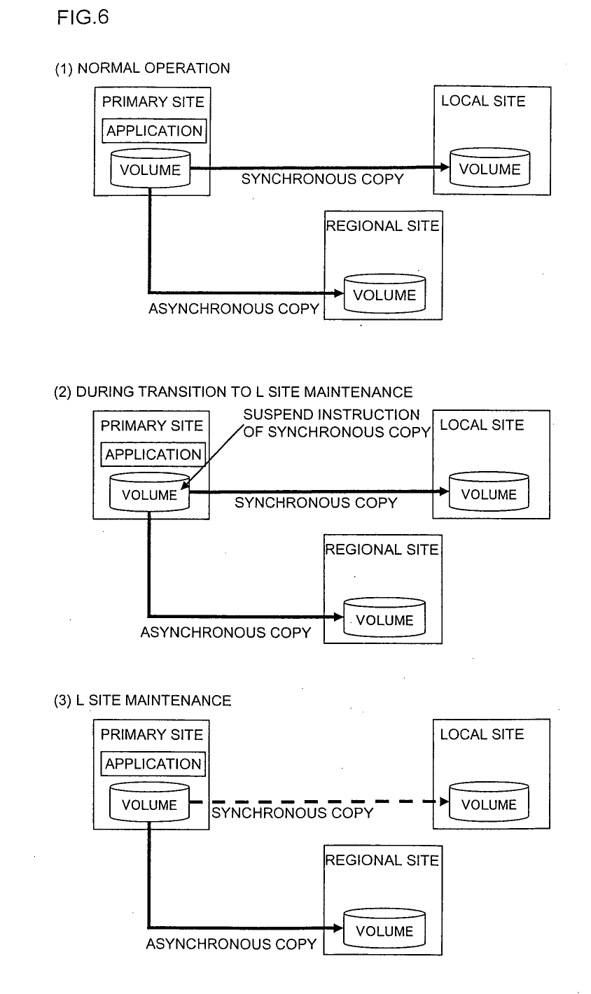

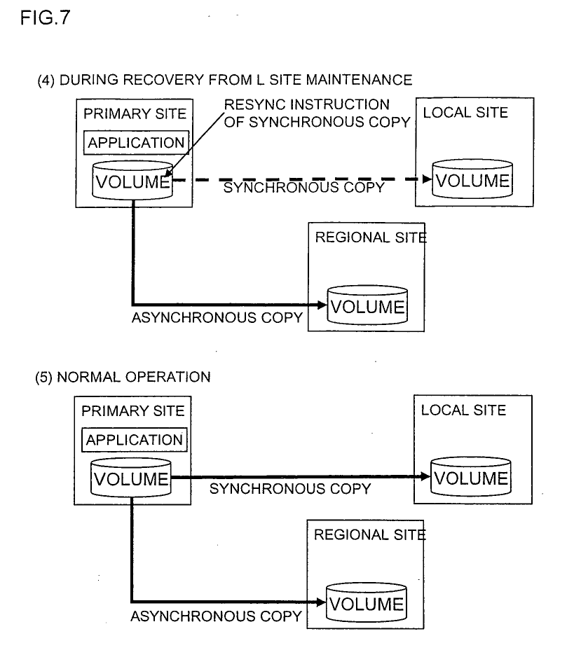

Referring to FIGS. 6 and 7, the operation of an “IL site maintenance” for suspending the operation of the local site alone for the maintenance in this embodiment will be described below. The normal multi-target organization as shown in FIG. 6(1) is taken before starting the maintenance. This site state is called a “normal operation”.

FIG. 6(2) shows the state where the organization is being changed to maintain the local site. The synchronous copy is suspended. These instructions are made by the local site administrator. This site state is called a “during transition to L site maintenance”.

FIG. 6(3) shows the state where the organization change of FIG. 6(2) is completed. The copy to the storage system 1500B at the local site is suspended, and the local site is ready for maintenance. This site state is called an “IL site maintenance”.

FIG. 7(4) shows the state of the organization change for restoring the state to the normal operation after performing the operation of FIG. 6(3). A resync instruction for the synchronous copy of CG.01 is made. This site state is called a “during recovery from L site maintenance”.

The “normal operation” as shown in FIG. 7(5) is restored by the organization change of FIG. 7(4). This state is the same as shown in FIG. 6(1).

The above description is involved in the procedure and organization for the operation associated with the “L site maintenance” in the multi-target.

Other operations than the above may be provided.

For example, there are a “P host down” in which only the host computer 1100A at the primary site fails, and an instance where the primary site and the local site suffer from disaster at the same time.

Though the procedure for changing the site state has been described above, these procedures are registered associated with the procedure name such as “STEPS01” identifiable by the user in the procedure data 8000. They may be in the form executable based on the designation of the user, such as the script.

FIG. 8 is a view showing the organization of a copy group information table 4000 of this embodiment. The copy group information table 4000 includes a copy group name 4110, a copy type 4120, a copy pair name 4130, a primary storage system name 4140, a primary volume ID 4150, a secondary storage system name 4160, and a secondary volume ID 4170.

The copy group name 4110 describes a name of copy group.

The copy type 4120 describes a type of copy. Herein, the “synchronous” indicates the synchronous copy and the “asynchronous” indicates the asynchronous copy.

The copy pair name 4130 describes a name of copy pair belonging to the copy group described in the copy group name 4120.

The primary storage system name 4140 describes a name of the storage system 1500 having the primary volume 1508 of the copy pair. The primary volume ID 4150 describes an identifier of the primary volume 1508 of the copy pair. The identifier of the volume 1508 is unique in the storage system 1500 having the volume 1508.

The secondary storage system name 4160 describes a name of the storage system 1500 having the secondary volume 1508 of the copy pair. The secondary volume ID 4170 describes an identifier of the secondary volume 1508 of the copy pair. The identifier of the volume 1508 is unique in the storage system 1500 having the volume 1508.

The row included in the copy group information table 4000 is the information defining the copy pair. For example, it is indicated that the copy pairs indicated in the rows 4210 to 4230 belongs to the copy group of CG.01 in FIG. 8.

FIG. 9 is a view showing the organization of a site state table 5000 of this embodiment. The site state table 5000 includes a site state name 5110, an existing condition 5120, a determination 5130, a primary site host 5140, a local site host 5150, a regional site host 5160, and a copy group state 5170. The site state name 5110 describes a name of site state.

The existing condition 5120 describes the information indicating the present site state. A description of “1” indicates the present site state and “0” indicates other states.

The determination 5130 describes the information for distinguishing whether or not the site state is determined based on the acquired information. When “0” is described, it is indicated that the site state is determined from the acquired information based on the conditions as described in the columns 5140 to 5170. When “1” is described, it is indicated that the site state transits by performing a procedure as will be described later.

The primary site host 5140 describes the condition as to whether the normal operation of the host agent 1106 performed in the host computer 1100 at the primary host is present or not to be applicable to the site state 5110. A description of “0” indicates a state where the agent stops, “1” indicates a state where the agent normally operates, and “2” indicates a state where the agent normally operates and the I/O is performed from the host computer 1102 to the storage system 1500 by the application 1108.

The local site host 5150 describes the condition as to whether the normal operation of the host agent 1106 performed in the host computer 1100 at the local site is present or not to be applicable to the site state 5110. The description method is the same as the primary site host 5140.

The regional site host 5160 describes the condition as to whether the normal operation of the host agent 1106 performed in the host computer 1100 at the regional site is present or not to be applicable to the site state 5110. The description method is the same as the primary site host 5140.

The copy group state 5170 describes the condition for the copy state of the copy group to be applicable to the site state 5110. For example, in the row 5210 of FIG. 9, to determine that the site state is the “normal operation”, there is a description of the conditions that the copy group with the copy group name of CG.01 is forward active in the copy, the copy group with the copy group name of CG.02 is forward active in the copy, and the copy group with the copy group name of CG.03 is inactive in the copy. Besides, the copy is forward active, but suspended due to a failure, or because the determination 5130 is “1”, the information “N/A” indicating no condition is described.

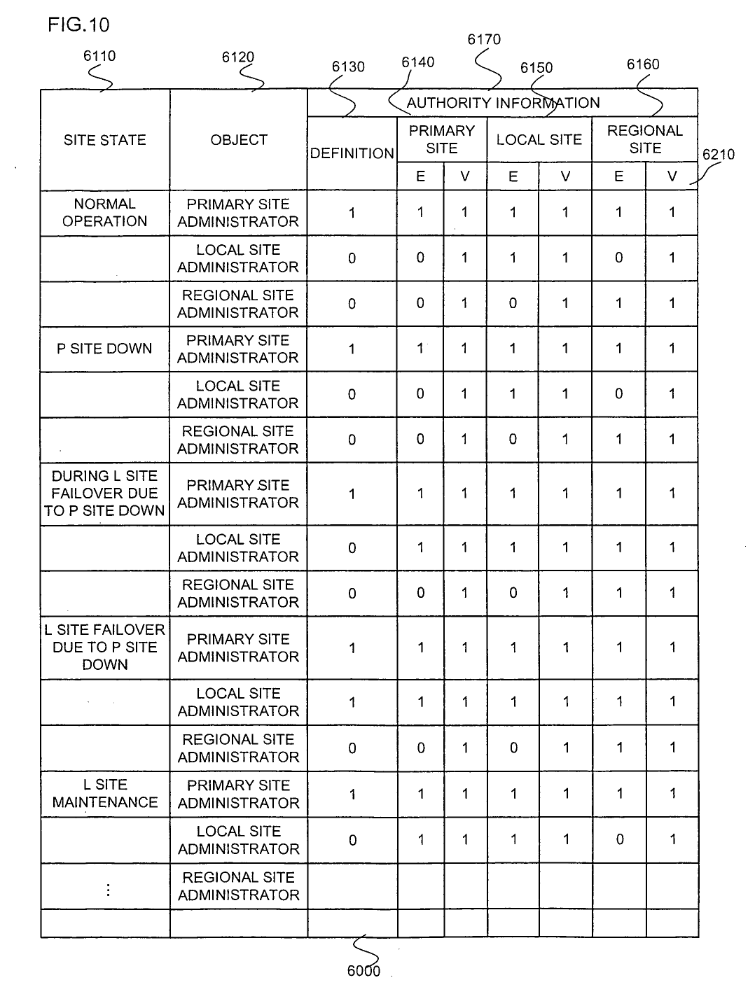

FIG. 10 is a view showing the organization of an authority table 6000 of this embodiment. The permissible authorities for each site administrator corresponding to the present site state acquired from the site state table as shown in FIG. 9 are defined. A description of “1” indicates the presence of the authority and “0” indicates the absence of the authority.

The authority table 6000 includes a site state 6110, an object 6120, a definition 6130, a primary site authority 6140, a local site authority 6150, and a regional site authority 6160. The site state 6110 describes a state of site.

The object 6120 describes the information indicating what administrator defines the authority. In the row 6210, the authority of the “primary site administrator” in the “normal operation” is defined.

The definition 6130 indicates the presence or absence of the authority for creating/editing or changing the copy group information table 4000.

The primary site authority 6140 indicates the presence or absence of the command issuance authority to the storage system at the primary site. Whether or not the command issuance concerning the configuration to the storage system 1500 via the host agent 1106 and the copy manager 1107 is permitted is indicated in “E”, and whether or not the command issuance concerning the information acquisition is permitted is indicated in “V”.

The local site authority 6150 indicates the presence or absence of the command issuance authority to the storage system at the local site. The description method is the same as the primary site authority 6140.

The local site authority 6160 indicates the presence or absence of the command issuance authority to the storage system at the regional site. The description method is the same as the primary site authority 6140.

The information concerning the authority as described from the definition 6130 to the regional site authority 6160 is collectively called the authority information 6170.

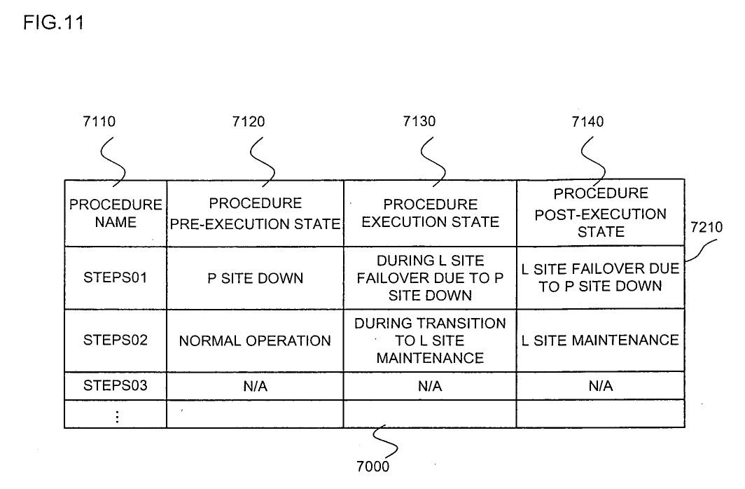

FIG. 11 is a view showing the organization of a procedure authority relevant table 7000 of this embodiment. For a procedure included in the procedure data 8000, the conditions that the primary site administrator changes the existing condition 5120 of the site state table 5000 depending on the presence or absence of performing the procedure and determines which site state is the present state are defined. A description of “N/A” indicates that there is the procedure name, but no designation of the state for change.

The procedure authority relevant table 7000 includes a procedure name 7110, a procedure pre-execution state 7120, a procedure execution state 7130, and a procedure post-execution state 7160. The procedure name 7110 describes a procedure name subject to the change of authority based on the site state among the operation procedures included in the procedure data 8000.

The procedure pre-execution state 7120 defines the site state before performing the procedure to check whether this site state is active.

The procedure execution state 7130 defines which site state is taken after starting the procedure until ending the procedure.

The procedure post-execution state 7140 defines which site state is taken after completing the procedure.

FIG. 12 is a flowchart showing a process of the procedure execution part 3200. First of all, the procedure execution processing part receiving a procedure execution request from the user determines whether or not the designated procedure is described in the procedure name 7110 by referring to the procedure authority management table 7000 (step S1201).

If the result of determination at step S1201 is true, the procedure pre-execution state 7120, the procedure execution state 7130 and the procedure post-execution state 7140 for the designated procedure are acquired from the row with the procedure name 7110 described, and whether or not the states are invalid such as “N/A” is determined (step S1202).

If the result of determination at step S1202 is true, it is determined whether or not the procedure pre-execution state 7120 is valid, and matched with the site state 5110 in which the existing condition 5120 in the site state table 5000 is “1” (S1203).

If the result of determination at step S1203 is true, the following process is performed. First of all, the existing condition 5120, which is “1” up to now, in the site state table 5000, is set to “0”, and the existing condition 5120 of the site state 5110 that is identical to the procedure execution state 7130 is set to “1” (step S1204).

The copy management part 3100 is instructed to perform the designated procedure (S1205). After performing the procedure, the existing condition 5120, which is “1” up to now, in the site state table 5000, is set to “0”, and the existing condition 5120 of the site state 5110 that is identical to the procedure post-execution state 7140 is set to “1” (step S1206).

If the result of determination at step S1201 is false, the result of determination at step S1202 is false, or the result of determination at step S1203 is false, the following process is performed.

First of all, a site state determination process is performed (S1207). The details will be described later. The copy management part 3100 is instructed to perform the designated procedure (S1208).

After performing the procedure, the site state determination process is performed (S1209). After performing the steps S1206 and S1209, the process is ended.

FIG. 13 is a flowchart for explaining a process of the site state determination part 3300 in this embodiment. First of all, the states of the site hosts 5140 to 5160 as described in the site state table 5000 are acquired from the response of the request to the host agent and the state of the described copy group 5170 is acquired by the management program (S1301).

The site state 5110 in which the states of the hosts and the copy group acquired at S1301 are matched with the conditions 5140 to 5170 as described in the site state table 5000 is acquired (S1302).

The existing condition 5120, which is “1” up to now, is set to “0”, and the existing condition 5120 of the site state acquired at step S1302 is set to “1” (S1303). The process is ended.

A second embodiment will be described below. Basically, the second embodiment is the same as the first embodiment, and the different points will be described below. In the first embodiment, one management program on the management computer is provided and the operation authority is determined based on the information within the table storing the information of the management program. On the contrary, there may be another management program for making the storage management other than the copy operation, for example, and the common authority information may be changed according to the invention.

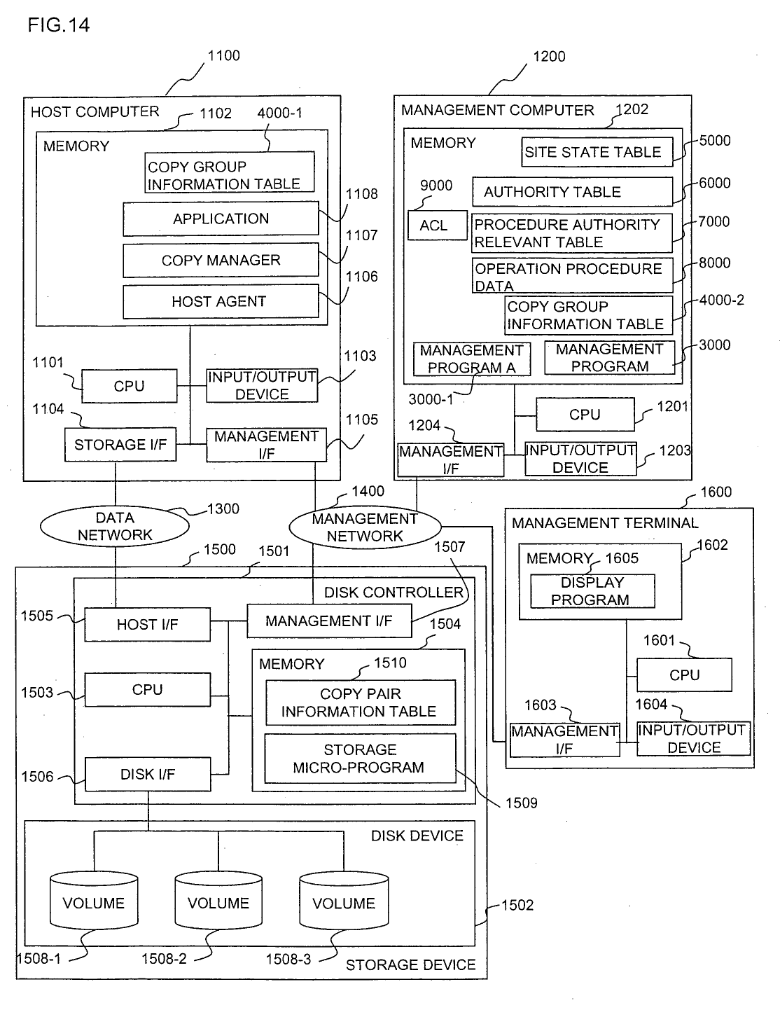

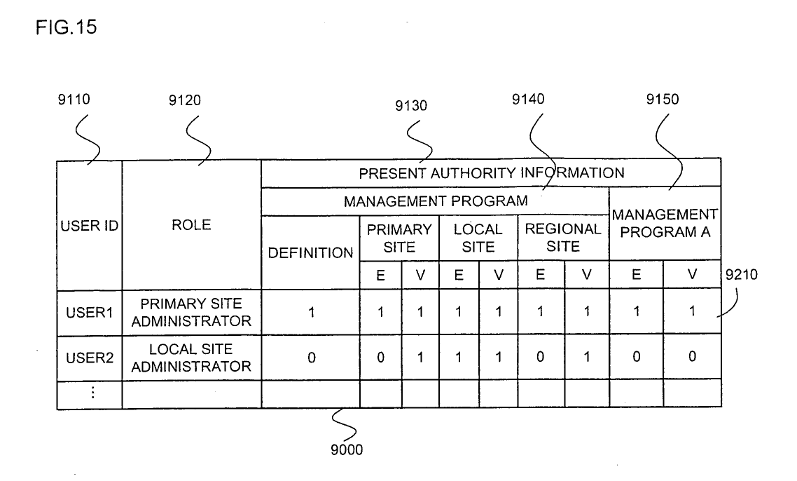

FIG. 14 shows the organization of a computer system according to this embodiment. In addition to the organization of the first embodiment, a management program A3000-1 and an ACL (Access Control List) 9000 are provided. The management program 3000 and the management program A3000-1 determine whether or not a request from the user is permitted based on the ACL 9000. The authority information 6170 of the authority table 6000 includes not only the authority information required for performing the management program 3000, but also the information that the ACL 9000 should hold for other programs. At steps S1204 and S1206 of the process of the procedure execution part 3200 and step S1303 of the process of the site state determination part 3300, not only the existing condition 5120 in the site state table 5000, but also the authority information 6170 of the authority table 6000 corresponding to the site state are configured in the ACL 9000 as the configuration of the authority.

FIG. 14 is a view showing the organization of the ACL 9000 of this embodiment. The ACL 9000 is composed of a user ID 9110, a role 9120 and the present authority information 9130.

The user ID 9110 is an area for storing the identifier specifying the user. The role 9120 is an area for storing the role of the corresponding user. The present authority information 9130 is an area for storing the authority information permitted for the corresponding user. The present authority information 9130 is composed of the authority information for each required management program as indicated at 9140 and 9150.

The configuration of these information is made for the user as the row indicated at 9210. When the authority information 6170 of the authority table 6000 applicable to the above site state is configured in the ACL 9000, the present authority information 9130 of the user ID 9110 having the role 9120 matched with the role as described in the object 6120 of the applicable site state 6110 in the authority table 6000 is changed to the contents of the corresponding authority information 6170.

While the embodiments of the invention have been described above, the GUI defining the site state table 5000, the authority table 6000, the procedure authority relevant table 7000, and the operation procedure data 8000, which are inputted by the user, may be prepared and defined via the management terminal 1600. At this time, the contents of the site state table 5000, the authority table 6000 and the procedure authority relevant table 7000 are displayed for only the user ID having the role of the primary site administrator, but not displayed for the user ID having other roles, thereby preventing the procedure and the authority from being illegally associated to permit an illegal operation.

Though the user's operation is performed by designating the procedure data of the operation procedure data 8000 in the embodiments of the invention, when the user's operation is performed via the GUI display of the management terminal 1600, the authority may be changed by determining whether or not its operation is matched with the operation procedure data 8000.

If any of one or more storage systems is provided with the functions of the management computer in the above embodiments, the management computer can be dispensed with.

Thus, the invention has been described above in connection with one embodiment. Another embodiment 1 of the invention is the computer system according to the invention, wherein if the copy configuration in the volume with the copy configuration in which it is associated in source and destination with other two or more volumes is changed and a certain user makes an operation request to any of the other two or more volumes, the management computer decides an operation authority to the user for the volume susceptible to the operation request, based on an attribute of the volume susceptible to the operation request, an attribute concerning the copy configuration after change of the volume susceptible to the operation request with another volume, and an attribute of another volume with the copy configuration after change, and suppresses the execution of the operation request, when the operation request is out of a permissible range of the operation authority.

Another embodiment 2 of the invention is the computer system according to the invention, wherein if the copy configuration in the volume with the copy configuration in which it is associated in source and destination with other two or more volumes is being changed and an operation request of a certain user to any of the other two or more volumes is acquired, the management computer decides no operation authority to the user for the volume susceptible to the operation request, and suppresses the execution of the operation request.

Another embodiment 3 of the invention is the computer system according to the invention, wherein if the storage system having a volume with the copy configuration in which it is associated in source and destination with other two or more volumes is in a state of primary site down, and a certain user makes an operation request to any of the volumes of the storage systems at a local site and a regional site, the management computer decides an operation authority to the user for the volume susceptible to the operation request, based on an attribute of the volume susceptible to the operation request, an attribute concerning the copy configuration after change of the volume susceptible to the operation request with another volume, and an attribute of another volume with the copy configuration after change, and suppresses the execution of the operation request, when the operation request is out of a permissible range of the operation authority.

Another embodiment 4 of the invention is a management computer for managing one or more storage systems having a volume usable from a host computer and making up a computer system in which a plurality of users can use the same volume, together with the one or more storage systems, wherein if the copy configuration in the volume with the copy configuration in which it is associated in source and destination with other two or more volumes is changed and a certain user makes an operation request to any of the two or more volumes, the management computer decides an operation authority to the user for the volume susceptible to the operation request, based on an attribute of the volume susceptible to the operation request, an attribute concerning the copy configuration after change of the volume susceptible to the operation request with another volume, and an attribute of another volume with the copy configuration after change, and suppresses the execution of the operation request, when the operation request is out of a permissible range of the operation authority.

Another embodiment 5 of the invention is a storage system having a volume usable from a host computer, managing other one or more storage systems, and making up a computer system in which a plurality of users can use the same volume, together with the other one or more storage systems, wherein if the copy configuration in the volume with the copy configuration in which it is associated in source and destination with other two or more volumes is changed and a certain user makes an operation request to any of the two or more volumes, the storage system decides an operation authority to the user for the volume susceptible to the operation request, based on an attribute of the volume susceptible to the operation request, an attribute concerning the copy configuration after change of the volume susceptible to the operation request with another volume, and an attribute of another volume with the copy configuration after change, and suppresses the execution of the operation request, when the operation request is out of a permissible range of the operation authority.

Another embodiment 6 of the invention is a volume management method for use in a computer system comprising one or more storage systems having a volume usable from a host computer and a management computer for managing the storage systems, in which a plurality of users can use the same volume, comprising a step of deciding an operation authority to the user for the volume susceptible to the operation request, based on an attribute of the volume susceptible to the operation request, an attribute concerning the copy configuration of another volume with a still another volume, and an attribute of another volume, if a certain user makes an operation request to the volume with the copy configuration in which it is associated in source and destination with another volume, and a step of suppressing the execution of the operation request, when the operation request is out of a permissible range of the operation authority.

Another embodiment 7 of the invention is the volume management method according to the invention, further comprising a step of deciding an operation authority to the user for the volume susceptible to the operation request, based on an attribute of the volume susceptible to the operation request, an attribute concerning the copy configuration after change of the volume susceptible to the operation request with another volume, and an attribute of another volume with the copy configuration after change, if the copy configuration in the volume with the copy configuration in which it is associated in source and destination with other two or more volumes is changed and a certain user makes an operation request to any of the other two or more volumes, and a step of suppressing the execution of the operation request, when the operation request is out of a permissible range of the operation authority.

Another embodiment 8 of the invention is the volume management method according to the invention, further comprising a step of deciding that there is no operation authority to the user for the volume susceptible to the operation request, if the copy configuration in the volume with the copy configuration in which it is associated in source and destination with other two or more volumes is being changed and an operation request of a certain user to any of the other two or more volumes is acquired, and a step of suppressing the execution of the operation request.

Another embodiment of 9 of the invention is the volume management method according to the invention, further comprising a step of deciding an operation authority to the user for the volume susceptible to the operation request, based on an attribute of the volume susceptible to the operation request, an attribute concerning the copy configuration after change of the volume susceptible to the operation request with another volume, and an attribute of another volume with the copy configuration after change, if the storage system having a volume with the copy configuration in which it is associated in source and destination with the other two or more volumes is in a state of primary site down, and a certain user makes an operation request to any of the volumes of the storage systems at a local site and a regional site, and suppressing the execution of the operation request, when the operation request is out of a permissible range of the operation authority.

What is claimed is:

1. A computer system comprising one or more storage systems having a volume usable from a host computer and a management computer for managing the storage systems, in which a plurality of users can use the same volume, wherein if a certain user makes an operation request to the volume with the copy configuration in which it is associated in source and destination with another volume, the management computer decides an operation authority to the user for the volume susceptible to the operation request, based on an attribute of the volume susceptible to the operation request, an attribute concerning the copy configuration of the another volume with a still another volume, and an attribute of the another volume, and suppresses the execution of the operation request, when the operation request is out of a permissible range of the operation authority.

2. The computer system according to claim 1, wherein if the copy configuration in the volume with the copy configuration in which it is associated in source and destination with other two or more volumes is changed and a certain user makes an operation request to any of the other two or more volumes, the management computer decides an operation authority to the user for the volume susceptible to the operation request, based on an attribute of the volume susceptible to the operation request, an attribute concerning the copy configuration after change of the volume susceptible to the operation request with another volume, and an attribute of the another volume with the copy configuration after change, and suppresses the execution of the operation request, when the operation request is out of a permissible range of the operation authority.

3. The computer system according to claim 1, wherein if the copy configuration in the volume with the copy configuration in which it is associated in source and destination with other two or more volumes is being changed and an operation request of a certain user to any of the other two or more volumes is acquired, the management computer decides no operation authority to the user for the volume susceptible to the operation request, and suppresses the execution of the operation request.

4. The computer system according to claim 1, wherein if the storage system having a volume with the copy configuration in which it is associated in source and destination with other two or more volumes is disabled, and a certain user makes an operation request to any of the other two or more volumes with the copy configuration, the management computer decides an operation authority to the user for the volume susceptible to the operation request, based on an attribute of the volume susceptible to the operation request, an attribute concerning the copy configuration after change of the volume susceptible to the operation request with another volume, and an attribute of the another volume with the copy configuration after change, and suppresses the execution of the operation request, when the operation request is out of a permissible range of the operation authority.

5. A management computer for managing one or more storage systems having a volume usable from a host computer and making up a computer system in which a plurality of users can use the same volume, together with the one or more storage systems, wherein if the copy configuration in the volume with the copy configuration in which it is associated in source and destination with other two or more volumes is changed and a certain user makes an operation request to any of the two or more volumes, the management computer decides an operation authority to the user for the volume susceptible to the operation request, based on an attribute of the volume susceptible to the operation request, an attribute concerning the copy configuration after change of the volume susceptible to the operation request with another volume, and an attribute of the another volume with the copy configuration after change, and suppresses the execution of the operation request, when the operation request is out of a permissible range of the operation authority.

6. A storage system having a volume usable from a host computer, managing other one or more storage systems, and making up a computer system in which a plurality of users can use the same volume, together with the other one or more storage systems, wherein if the copy configuration in the volume with the copy configuration in which it is associated in source and destination with other two or more volumes is changed and a certain user makes an operation request to any of the two or more volumes, the storage system decides an operation authority to the user for the volume susceptible to the operation request, based on an attribute of the volume susceptible to the operation request, an attribute concerning the copy configuration after change of the volume susceptible to the operation request with another volume, and an attribute of the another volume with the copy configuration after change, and suppresses the execution of the operation request, when the operation request is out of a permissible range of the operation authority.

7. A volume management method for use in a computer system comprising one or more storage systems having a volume usable from a host computer and a management computer for managing the storage systems, in which a plurality of users can use the same volume, comprising a step of deciding an operation authority to the user for the volume susceptible to the operation request, based on an attribute of the volume susceptible to the operation request, an attribute concerning the copy configuration of the another volume with a still another volume, and an attribute of the another volume, if a certain user makes an operation request to the volume with the copy configuration in which it is associated in source and destination with another volume, and a step of suppressing the execution of the operation request, when the operation request is out of a permissible range of the operation authority.

8. The volume management method according to claim 7, further comprising a step of deciding an operation authority to the user for the volume susceptible to the operation request, based on an attribute of the volume susceptible to the operation request, an attribute concerning the copy configuration after change of the volume susceptible to the operation request with another volume, and an attribute of the another volume with the copy configuration after change, if the copy configuration in the volume with the copy configuration in which it is associated in source and destination with other two or more volumes is changed and a certain user makes an operation request to any of the other two or more volumes, and a step of suppressing the execution of the operation request, when the operation request is out of a permissible range of the operation authority.

9. The volume management method according to claim 7, further comprising a step of deciding that there is no operation authority to the user for the volume susceptible to the operation request, if the copy configuration in the volume with the copy configuration in which it is associated in source and destination with other two or more volumes is being changed and an operation request of a certain user to any of the other two or more volumes is acquired, and a step of suppressing the execution of the operation request.

10. The volume management method according to claim 7, further comprising a step of deciding an operation authority to the user for the volume susceptible to the operation request, based on an attribute of the volume susceptible to the operation request, an attribute concerning the copy configuration after change of the volume susceptible to the operation request with another volume, and an attribute of the another volume with the copy configuration after change, if the storage system having a volume with the copy configuration in which it is associated in source and destination with the other two or more volumes is disabled, and a certain user makes an operation request to any of the other two or more volumes with the copy configuration, and suppressing the execution of the operation request, when the operation request is out of a permissible range of the operation authority.
